(19) United States
(12) Patent Application Publication
(10) Pub. No.: US 2011/0261106 A1
(43) Pub. Date: Oct. 27, 2011

(54) Carriage unit, liquid ejection recording device, and method of affixing carriage unit

(76) Inventor: Tetsuya Murase, Chiba (JP)

(21) Appl. No.: 12/998,814

(22) PCT Filed: Nov. 27, 2009
(86) PCT No.: PCT/JP2009/070048

§ 371 Date: Jul. 1, 2011

(30) Foreign Application Priority Data
Dec. 4, 2008 (JP) 2008-309787

(51) Int. Cl. B41J 2/01

(52) U.S. Cl. 347/20

(57) ABSTRACT

Provided is a carriage unit which enables easy attachment/detachment of a liquid jet head (4) to/from a carriage (62a) and which enables securement of positioning accuracy of the liquid jet head (4) with respect to the carriage (62a). The carriage unit includes: the liquid jet head (4) having a plurality of jetting holes arranged therein, for jetting liquid toward a recording surface of a recording medium; and the carriage (62a) which relatively moves in parallel with the recording surface under a state in which the liquid jet head (4) is fixed thereto, in which: the carriage unit further includes a lever (80) for detachably fixing the liquid jet head (4) by rotating and engaging the lever (80) with respect to the carriage (62a); and the liquid jet head (4) is positioned with respect to the carriage (62a) in respective directions with rotating operation and engaging operation of the lever (80).

### TECHNICAL FIELD

The present invention relates to a carriage unit, a liquid jet recording apparatus, and a method for fixing a carriage unit.

### BACKGROUND ART

There has been provided a liquid jet recording apparatus, such as a printer or a facsimile machine, for recording an image, text, or the like by jetting ink droplets on recording paper or the like. The liquid jet recording apparatus includes a liquid jet head having a plurality of jetting holes arranged therein, for jetting liquid toward a recording surface of a recording medium. The liquid jet head is formed in a shape of a rectangle viewed from a direction of a normal to the recording surface of the recording medium under a state in which a direction of arrangement of the plurality of jetting holes is a direction of a long side thereof and a direction orthogonal to the direction of the long side is a direction of a short side thereof. The liquid jet head is mounted on a carriage to form a carriage unit. By jetting liquid from the liquid jet head while the carriage unit is moved in the direction of the short side and the recording medium is transferred in the direction of the long side, the recording on the recording medium is performed.

With regard to a structure for fixing a liquid jet head to a carriage, screwing is generally employed. It is to be noted that Patent Documents 1 and 2 disclose fixing structures for engaging a liquid jet head with respect to a carriage in order to easily and promptly conduct the work to attach the ink jet head.
Patent Document 1: JP 2003-170575 A
Patent Document 2: JP 2002-210929 A

### DISCLOSURE OF THE INVENTION

### Problems to be solved by the Invention

However, the work to attach/detach a liquid jet head to/from a carriage is required to be conducted more easily and more promptly.

Further, in order to improve recording accuracy of a liquid jet recording apparatus, positioning of a liquid jet head with respect to a carriage is important. In the case of the above-mentioned fixing structure employing screwing, positioning of a liquid jet head is carried out by screwing the liquid jet head against a carriage with regard to a horizontal direction. However, in this case, there is a possibility that the liquid jet head is rotated due to screwing torque to cause minute misalignment. Further, it is also difficult to secure positioning accuracy even in the fixing structure disclosed in Patent Documents 1 and 2.

The present invention has been made in view of the above-mentioned problems, and an object of the present invention is to provide a carriage unit, a liquid jet recording apparatus, and a method for fixing a carriage unit which enable easy attachment/detachment of a liquid jet head to/from a carriage and which enable securement of positioning accuracy of the liquid jet head with respect to the carriage.

### Means for solving the Problems

In order to solve the above-mentioned problems, a carriage unit according to the present invention includes: a liquid jet head having a plurality of jetting holes arranged therein for jetting liquid toward a recording surface of a recording medium; and a carriage which relatively moves in parallel with the recording surface under a state in which the liquid jet head is fixed thereto, in which: the carriage unit further includes a first lever for detachably fixing the liquid jet head by rotating and engaging the first lever with respect to the carriage; and the liquid jet head is positioned with respect to the carriage at least in a plane in parallel with the recording surface with rotating operation and engaging operation of the first lever.

According to the present invention, the first lever for detachably fixing the liquid jet head by rotating and engaging the first lever with respect to the carriage is included, and thus, attachment/detachment of the liquid jet head may be conducted easily only by rotating and engaging the first lever. Further, positioning of the liquid jet head is carried out with the rotating operation and the engaging operation of the first lever, and thus, positioning of the liquid jet head may be carried out easily.

Further, it is preferred that the liquid jet head be formed in a shape of a rectangle viewed from a direction of a normal to the recording surface under a state in which a direction of arrangement of the plurality of jetting holes is a direction of a long side thereof and a direction orthogonal to the direction of the long side is a direction of a short side thereof, the carriage include: a housing portion for housing at least a part of the liquid jet head; a supporting portion disposed on one side in the direction of the long side adjacent to the housing portion, for rotatably supporting the first lever; and an engaging portion disposed on an other side in the direction of the long side adjacent to the housing portion for engaging with the first lever, a first protrusion which protrudes in the direction of the long side and a second protrusion which protrudes in the direction of the short side be formed on a side surface of one of the liquid jet head and the housing portion, and the liquid jet head be positioned with respect to the carriage in the direction of the long side and in the direction of the short side by causing the first protrusion and the second protrusion to be in abutting contact with a side surface of the other of the liquid jet head and the housing portion.

According to the present invention, the positioning is carried out by causing the first protrusion and the second protrusion to be in abutting contact with the side surface of the housing portion, and thus, positioning of the liquid jet head may be carried out with high accuracy.

Further, it is preferred that the carriage unit further include a first pressing portion formed on the supporting portion side of the first lever, for carrying out positioning of the supporting portion side of the liquid jet head with respect to the carriage in the direction of the short side and carrying out positioning of the whole liquid jet head with respect to the carriage in the direction of the long side by pressing the supporting portion side of the liquid jet head with respect to the carriage in the direction of the short side and in the direction of the long side with the rotating operation of the first lever.

According to the present invention, only by rotating the first lever, positioning of the supporting portion side of the liquid jet head in the direction of the short side may be carried out, and in addition, positioning of the whole liquid jet head in the direction of the long side may be carried out. Therefore, positioning of the liquid jet head may be carried out easily.

Further, it is preferred that carriage unit further include a second pressing portion formed on the supporting portion side of the first lever, for carrying out positioning by pressing the supporting portion side of the liquid jet head with respect to the carriage in the direction of the normal with the rotating operation of the first lever, in which after the first pressing portion carries out positioning of the liquid jet head in the direction of the long side and in the direction of the short side, the second pressing portion carries out positioning of the liquid jet head in the direction of the normal.

According to the present invention, only by rotating the first lever, positioning of the supporting portion side of the liquid jet head in the direction of the normal may be carried out, and thus, positioning of the liquid jet head may be carried out easily. In addition, positioning in the direction of the normal is carried out after positioning of the supporting portion side of the liquid jet head in the direction of the short side is carried out, and thus, positioning in the direction of the normal does not interfere with positioning in the direction of the short side. Therefore, positioning of the liquid jet head may be carried out with high accuracy.

Further, it is preferred that the carriage unit further include a third pressing portion formed on the engaging portion side of the first lever, for carrying out positioning by pressing the engaging portion side of the liquid jet head with respect to the carriage in the direction of the short side and in the direction of the normal with the engaging operation of the first lever.

According to the present invention, only by engaging the first lever, positioning of the engaging portion side of the liquid jet head in the direction of the short side and in the direction of the normal may be carried out, and thus, positioning of the liquid jet head may be carried out easily. Further, with regard to the rectangular liquid jet head, by separately carrying out positioning on the supporting portion side and positioning on the engaging portion side, positioning of the liquid jet head may be carried out with high accuracy.

Further, it is preferred that the carriage unit further include a pressing mechanism provided on the engaging portion side of the carriage, for carrying out positioning by pressing the engaging portion side of the liquid jet head with respect to the carriage in the direction of the short side in synchronization with the engaging operation of the first lever.

According to the present invention, the pressing mechanism for pressing the liquid jet head in synchronization with the engaging operation of the first lever is included, and thus, even if it is difficult to press the liquid jet head with the first lever itself, for example, even if the liquid jet head is covered with a cover, the pressing mechanism may press the liquid jet head to carry out the positioning.

Further, it is preferred that the carriage unit further include a second lever provided on the engaging portion side of the carriage, for carrying out positioning by pressing the engaging portion side of the liquid jet head with respect to the carriage in the direction of the normal.

According to the present invention, the second lever for pressing the liquid jet head is included, and thus, even if it is difficult to press the liquid jet head with the first lever itself, the second lever may press the liquid jet head to carry out the positioning.

It should be noted that the housing portion may be a groove portion.

Further, the housing portion may be a through hole.

Further, the first lever is formed by bending a steel wire material.

According to the present invention, the first lever may be formed at low cost, and thus, the manufacturing cost may be reduced.

Further, a liquid jet recording apparatus according to the present invention includes carriage moving means for moving the carriage unit described above and recording medium transfer means for transferring the recording medium.

According to the present invention, the carriage unit having the highly accurately positioned liquid jet head is included, and thus, liquid may be jetted from jetting holes of the liquid jet head toward a recording surface of the recording medium with high accuracy. Therefore, a liquid jet recording apparatus with high recording accuracy may be provided.

Further, a method for fixing a carriage unit according to the present invention, the carriage unit including: a liquid jet head having a plurality of jetting holes arranged therein, for jetting liquid toward a recording surface of a recording medium, the liquid jet head being formed in a shape of a rectangle viewed from a direction of a normal to the recording surface under a state in which a direction of arrangement of the plurality of jetting holes is a direction of a long side thereof and a direction orthogonal to the direction of the long side is a direction of a short side thereof; and a carriage which relatively moves in parallel with the recording surface under a state in which the liquid jet head is fixed thereto, the method for fixing a carriage unit being a method for fixing the liquid jet head with respect to the carriage, the method for fixing a carriage unit includes: a long side direction fixing step of fixing the liquid jet head with respect to the carriage in the direction of the long side; a short side direction fixing step of fixing the liquid jet head with respect to the carriage in the direction of the short side; and a normal direction fixing step of fixing the liquid jet head with respect to the carriage in the direction of the normal, the normal direction fixing step being completed after the long side direction fixing step and the short side direction fixing step are completed or simultaneously with completion of the long side direction fixing step and the short side direction fixing step.

Generally, it is difficult to carry out positioning of a liquid jet head in the direction of the long side and in the direction of the short side under a state in which force for fixing the liquid jet head in the direction of the normal is acting. In contrast, according to the present invention, the normal direction fixing step is completed after the long side direction fixing step and the short side direction fixing step are completed or simultaneously with completion of the long side direction fixing step and the short side direction fixing step, and thus, positioning and fixing of the liquid jet head with respect to the carriage in the respective directions may reliably be carried out.

### Effects of the Invention

According to the carriage unit of the present invention, the first lever for detachably fixing the liquid jet head by rotating and engaging the first lever with respect to the carriage is included, and thus, attachment/detachment of the liquid jet head may be conducted easily only by rotating and engaging the first lever. Further, positioning of the liquid jet head is carried out with the rotating operation and the engaging operation of the first lever, and thus, positioning of the liquid jet head may be carried out easily.

### BRIEF DESCRIPTION OF THE DRAWINGS

FIG. 1 is a perspective view illustrating a liquid jet recording apparatus.

FIG. 2 is a perspective view illustrating a liquid jet head.

FIG. 3 is a perspective view illustrating a head chip.

FIG. 4 is an explanatory diagram of a carriage unit according to a first embodiment, and is an exploded perspective view of a base portion of a carriage and the liquid jet head.

FIG. 5(a) is a plan view of a lever viewed from a −Z direction and FIG. 5(b) is a side view of the lever viewed from a −X direction.

FIG. 6 is an explanatory diagram of operation of disposing the liquid jet head on the carriage.

FIG. 7 is an explanatory diagram of the operation of disposing the liquid jet head on the carriage.

FIG. 8 is an explanatory diagram of pressing operation by a first pressing portion.

FIG. 9 is an explanatory diagram of the pressing operation by the first pressing portion.

FIG. 10 is an explanatory diagram of pressing operation by a second pressing portion and a third pressing portion.

FIG. 11 is an explanatory diagram of the pressing operation by the second pressing portion and the third pressing portion.

FIG. 12 is a perspective view of a carriage in a carriage unit according to a second embodiment.

FIG. 13 is a perspective view of the carriage in the carriage unit according to the second embodiment.

FIG. 14 is a perspective view of a carriage in a carriage unit according to a third embodiment.

FIG. 15 is a perspective view of the carriage unit according to the third embodiment.

FIG. 16 is a perspective view of the carriage unit according to the third embodiment.

### BEST MODES FOR CARRYING OUT THE INVENTION

Embodiments of the present invention are described in the following with reference to the attached drawings.

### (Liquid Jet Recording Apparatus)

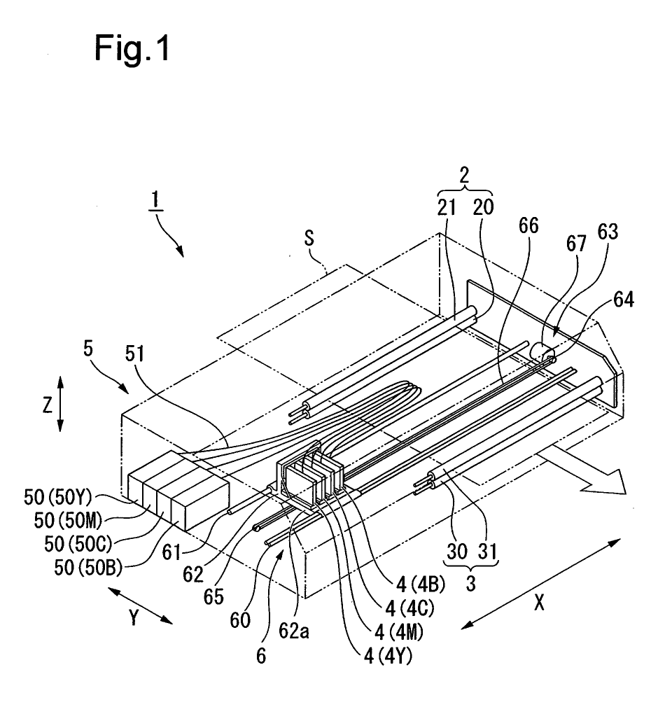

FIG. 1 is a perspective view illustrating a liquid jet recording apparatus. A liquid jet recording apparatus 1 includes a pair of transfer means 2 and 3 for transferring a recording medium S such as paper, liquid jet heads 4 for discharging ink toward the recording medium S, ink supply means 5 for supplying ink to the liquid jet heads 4, and scanning means 6 for causing the liquid jet heads 4 to scan in a direction (auxiliary scan direction) which is substantially orthogonal to a transfer direction (main scan direction) of the recording medium S.

The pair of transfer means 2 and 3 include grid rollers 20 and 30 which are provided so as to extend in the auxiliary scan direction, pinch rollers 21 and 31 which are provided so as to extend in parallel with the grid rollers 20 and 30, and drive mechanisms (not shown),such as motors, for axially rotating the grid rollers 20 and 30 respectively.

The ink supply means 5 includes ink tanks 50 for housing ink and ink supply tubes 51 for connecting the ink tanks 50 and the liquid jet heads 4. The plurality of ink tanks 50 are, more specifically, ink tanks 50Y, 50M, 50C, and 50B provided side by side for four kinds of ink: yellow; magenta; cyan; and black. The ink supply tubes 51 are flexible hoses having flexibility so as to be able to accommodate movement of the liquid jet heads 4 (carriage unit 62).

The scanning means 6 includes a pair of guide rails 60 and 61 which are provided so as to extend in the auxiliary scan direction, a carriage unit 62 which is slidable along the pair of guide rails 60 and 61, and a drive mechanism 63 for moving the carriage unit 62 in the auxiliary scan direction. The drive mechanism 63 includes a pair of pulleys 64 and 65 that are arranged between the pair of guide rails 60 and 61, an endless belt 66 which is looped over the pair of pulleys 64 and 65, and a drive motor 67 for rotationally driving one pulley 64 of the pulleys. The pair of pulleys 64 and 65 are arranged between both end portions of the pair of guide rails 60 and 61, respectively, and are spaced in the auxiliary scan direction. The endless belt 66 is arranged between the pair of guide rails 60 and 61, and the carriage unit 62 is coupled to the endless belt. The plurality of liquid jet heads 4 are mounted on the carriage unit 62. More specifically, liquid jet heads 4Y, 4M, 4C, and 4B are mounted side by side in the auxiliary scan direction for the four kinds of ink: yellow; magenta; cyan; and black.

(Liquid Jet Head)

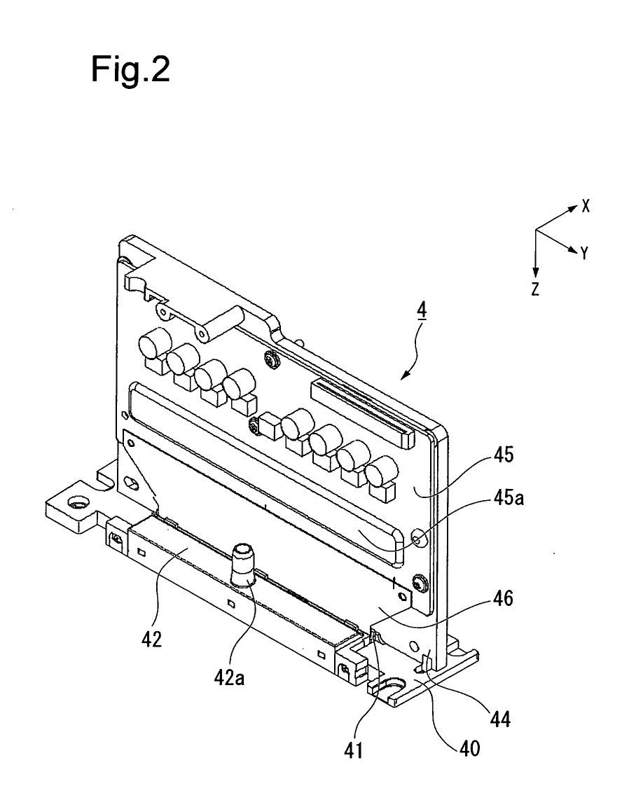

FIG. 2 is a perspective view illustrating the liquid jet head. The liquid jet head 4 includes an attaching base 40, a liquid jet head chip 41, a flow path substrate 42, a base plate 44, and a wiring substrate 45. It is to be noted that the attaching base 40 and the base plate 44 may be separate from each other or may be integrally formed.

The attaching base 40 is formed substantially in the shape of a rectangle viewed from a Z direction. A notch is provided in the attaching base 40 from a middle portion in a direction of a long side thereof toward a surface of the base plate 44. A liquid jet head chip (hereinafter, simply referred to as head chip) 41 is attached in the recess of the notch.

The flow path substrate 42 is attached to one surface side of the head chip 41. A circulating path (not shown) for circulating ink is formed in the flow path substrate 42, and a flow inlet 42a for communicating with the circulating path is formed on an upper surface of the flow path substrate 42. A pressure regulating portion (not shown) for absorbing pressure fluctuations of ink is coupled to the flow inlet 42a.

The base plate 44 is substantially perpendicularly provided on an upper surface of the attaching base 40, and the wiring substrate 45 is attached to a surface thereof. A control circuit 45a for controlling operation of the head chip 41 is formed on the wiring substrate 45. The wiring substrate 45 and the head chip 41 are electrically connected via a flexible substrate 46.

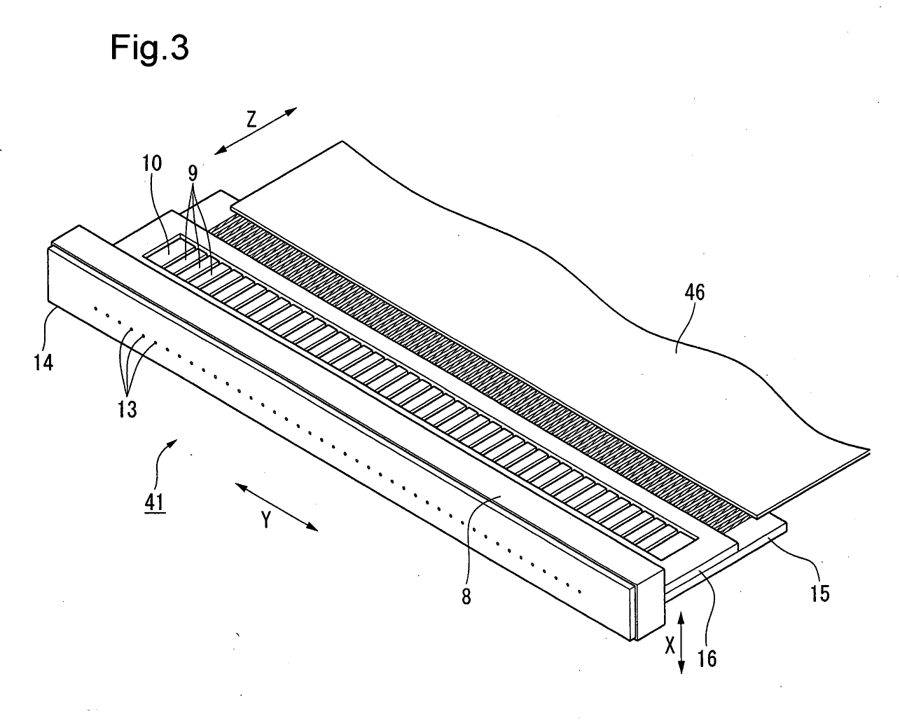

FIG. 3 is a perspective view illustrating the head chip. The head chip 41 includes an ink chamber 10 for housing ink, a plurality of channels (not shown) formed side by side by partitioning with piezoelectric elements which are deformable by applying voltage thereto, and nozzle holes 13 for discharging ink droplets toward a recording medium.

More specifically, the head chip 41 is a so-called independent channel type head chip, and includes a nozzle plate 14 having the nozzle holes 13 formed therein, an actuator plate 15 in which the plurality of piezoelectric elements are provided side by side so as to be upright with space interposed therebetween, to thereby form the plurality of channels, an ink chamber plate 16 having the ink chamber 10 formed therein, and a nozzle cap 8 for supporting the nozzle plate 14. The actuator plate 15 is a rectangular plate formed of a piezoelectric material such as lead zirconate titanate (PZT).

The head chip 41 is attached to the liquid jet head 4 illustrated in FIG. 2 with the nozzle plate being directed downward so that the nozzle plate of the head chip 41 is disposed in parallel with a recording surface of a recording medium. A direction of arrangement of the nozzle holes of the head chip 41 is a direction of a long side of the liquid jet head 4, while a direction orthogonal to the direction of the long side is a direction of a short side of the liquid jet head 4. More specifically, the liquid jet head 4 is formed substantially in the shape of a rectangle viewed from a direction of a normal to the recording surface of the recording medium. The direction of the long side of the liquid jet head, the direction of the short side of the liquid jet head, and the direction of the normal to the recording surface of the recording medium are hereinafter referred to as a Y direction, an X direction, and a Z direction, respectively.

The liquid jet heads 4 are mounted on the carriage unit 62 of the liquid jet recording apparatus illustrated in FIG. 1 under a state in which the direction of the long side thereof (Y direction) is aligned with the main scan direction while the direction of the short side thereof (X direction) is aligned with the auxiliary scan direction. Further, the plurality of liquid jet heads 4 are mounted side by side in the X direction on the carriage unit 62. By jetting ink droplets from the liquid jet head 4 while the recording medium is transferred in the Y direction and the carriage unit 62 is moved in the X direction, recording is performed on the recording medium.

(Carriage Unit)

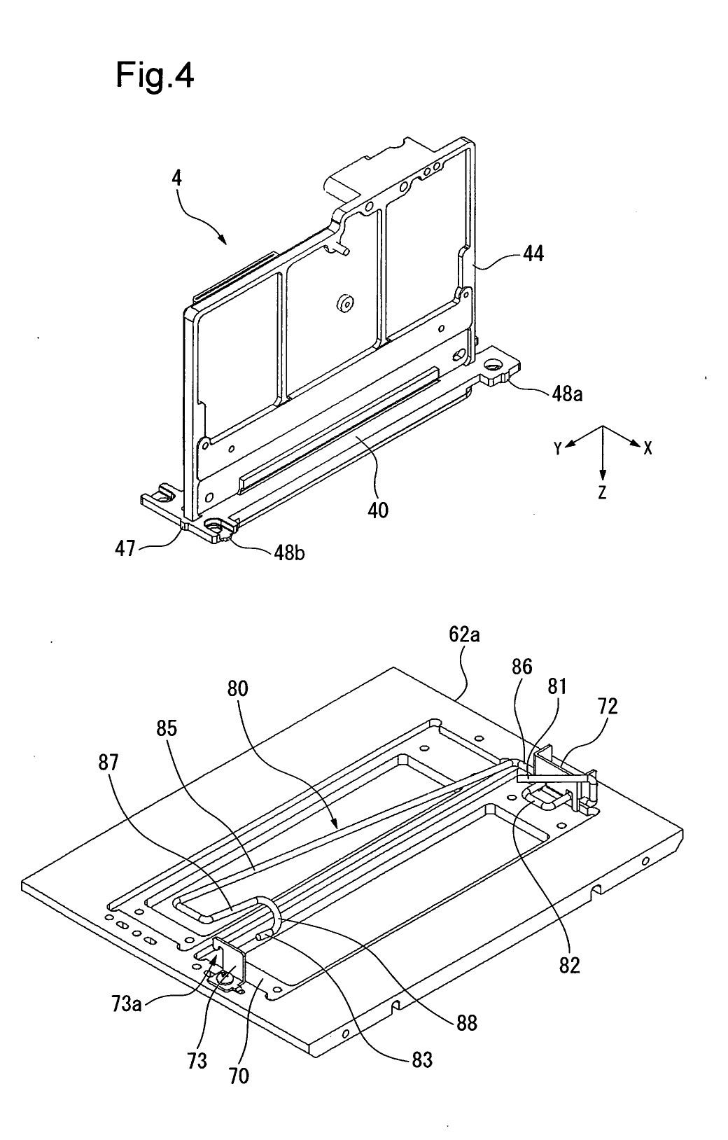

FIG. 4 is an explanatory diagram of a carriage unit according to a first embodiment, and is an exploded perspective view of a base portion of a carriage and the liquid jet head. It is to be noted that a base portion of a carriage 62a is a portion on which the liquid jet head 4 is mounted, and is disposed so as to be in parallel with the recording surface of the recording medium. The carriage 62a is formed of a metal material such as an aluminum alloy or stainless steel. A groove portion 70 as a housing portion for housing the attaching base 40 of the liquid jet head 4 is provided in the carriage 62a. The groove portion 70 is formed substantially in the shape of a rectangle viewed from the Z direction, and the rectangle is a size slightly larger than the liquid jet head. It is to be noted that a through hole through which ink droplets jetted from the liquid jet head pass is formed in the middle of the groove portion 70.

A first protrusion 47 which protrudes in a +Y direction is formed on a side surface of the attaching base 40 of the liquid jet head 4 in the +Y direction. By causing the first protrusion 47 to be in abutting contact with a side surface of the groove portion 70 in the +Y direction, positioning of the liquid jet head 4 with respect to the carriage 62a in the Y direction is carried out. Further, a pair of second protrusions 48a and 48b which protrude in a +X direction are formed on a side surface of the attaching base 40 of the liquid jet head 4 in the +X direction. One protrusion 48a of the second protrusions is disposed on a −Y direction side of the attaching base 40 while the other protrusion 48b of the second protrusions is disposed on the +Y direction side of the attaching base 40. By causing the pair of second protrusions 48a and 48b to be in abutting contact with a side surface of the groove portion 70 in the +X direction, positioning of the liquid jet head 4 with respect to the carriage 62a in the X direction is carried out.

A lever (first lever) 80 is attached to the carriage 62a. The lever 80 is formed by bending a steel wire material such as stainless steel. The lever 80 is provided for detachably fixing the liquid jet head 4 by rotating the lever 80 with respect to and engaging the lever 80 with the carriage 62a. It is to be noted that a supporting portion 72 for rotatably supporting the lever 80 is provided adjacent to the groove portion 70 in the −Y direction. Further, an engaging portion 73 for engaging with and fixing the lever 80 is provided adjacent to the groove portion 70 in the +Y direction. An engaging concave portion 73a in the shape of a hook which is open downward is provided for the engaging portion 73.

The lever 80 includes a linear portion 85 which extends in the Y direction. The linear portion 85 is formed so that the length thereof is equivalent to that of the groove portion 70 in the Y direction, and is disposed outside the groove portion 70 in a −X direction.

Further, the lever 80 includes a rotation shaft portion 86 which extends in the +X direction from a −Y direction end portion of the linear portion 85. The rotation shaft portion 86 is formed so that the length thereof is equivalent to that of the groove portion 70 in the X direction, and is disposed outside the groove portion 70 in the −Y direction. It is to be noted that the above-mentioned supporting portion 72 rotatably supports the rotation shaft portion 86 of the lever 80.

Further, the lever 80 includes a first pressing portion 81 which extends in a −Z direction from a +X direction end portion of the rotation shaft portion 86, and then extends obliquely in the −X direction and in the +Y direction. The first pressing portion 81 is provided for pressing a side edge portion of the base plate 44 of the liquid jet head 4 in the +X direction and in the +Y direction with rotating operation of the lever 80.

Further, the lever 80 includes a second pressing portion 82 which is formed by bending a middle portion of the rotation shaft portion 86 in a length direction toward the +Y direction. The second pressing portion 82 is provided for pressing a supporting portion 72 side of the attaching base 40 of the liquid jet head 4 in a +Z direction with rotating operation of the lever 80.

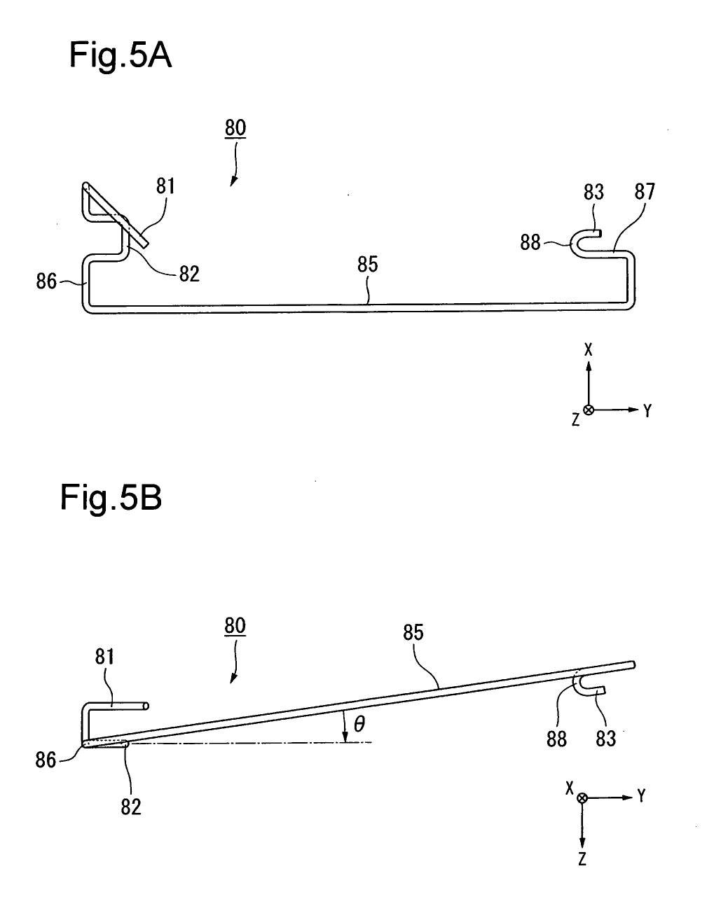

FIG. 5(a) is a plan view of the lever viewed from the −Z direction and FIG. 5(b) is a side view of the lever viewed from the −X direction. As illustrated in FIG. 5(b), a plane including the second pressing portion 82 is disposed in a +θ direction with respect to a plane including the linear portion 85 and the rotation shaft portion 86. When the linear portion 85 of the lever 80 is rotated in the +θ direction from the state illustrated in FIG. 5(b), the second pressing portion 82 is also rotated in the +θ direction. This causes the liquid jet head which is disposed on the +Z direction side of the second pressing portion 82 to be pressed.

Reference is again made to FIG. 4. The lever 80 includes a folded portion 87 which extends in the +X direction from a +Y direction end portion of the linear portion 85 and then is folded in the −Y direction. It is to be noted that the engaging concave portion 73a of the engaging portion 73 described above is engaged with the folded portion 87 of the lever 80.

Further, the lever 80 includes a U-shaped portion 88 which obliquely extends in the +X direction and in the +Z direction and then which extends in the +Y direction from a −Y direction end portion of the folded portion 87. Further, a third pressing portion 83 which extends in the +Y direction is provided at a tip of the U-shaped portion 88. The third pressing portion 83 is provided for pressing an engaging portion 73 side of the base plate 44 of the liquid jet head 4 in the +X direction and pressing the engaging portion 73 side of the attaching base 40 in the +Z direction with engaging operation of the lever 80.

As described above, in the lever 80 according to this embodiment, by bending the steel wire material, the first pressing portion 81, the second pressing portion 82, and the third pressing portion 83 are formed. According to the structure, the lever 80 may be formed at low cost, and thus, the manufacturing cost may be reduced.

(Method of Positioning and Fixing Liquid Jet Head)

Next, a method of positioning of fixing the liquid jet head in the carriage unit according to this embodiment is described.

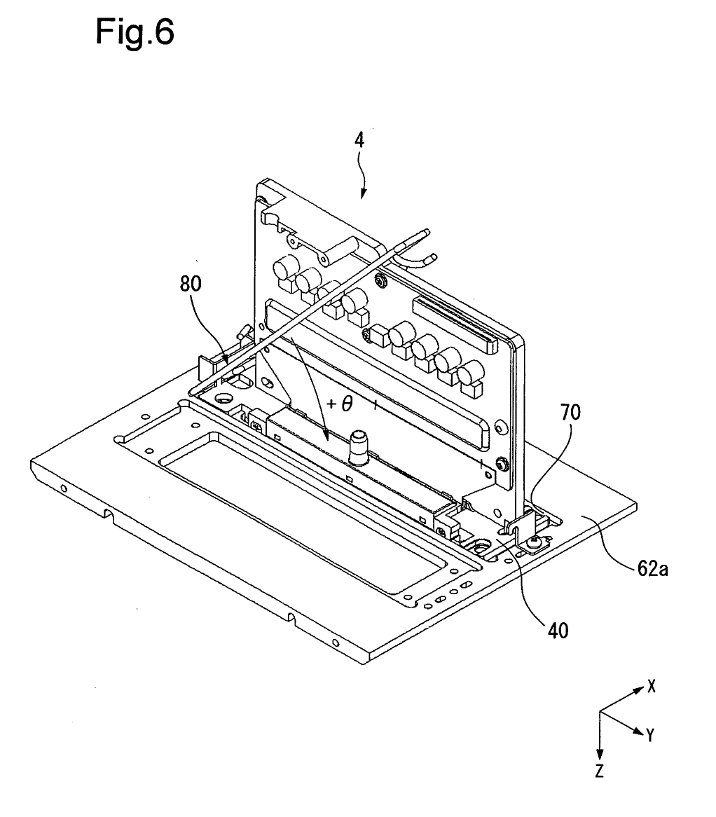

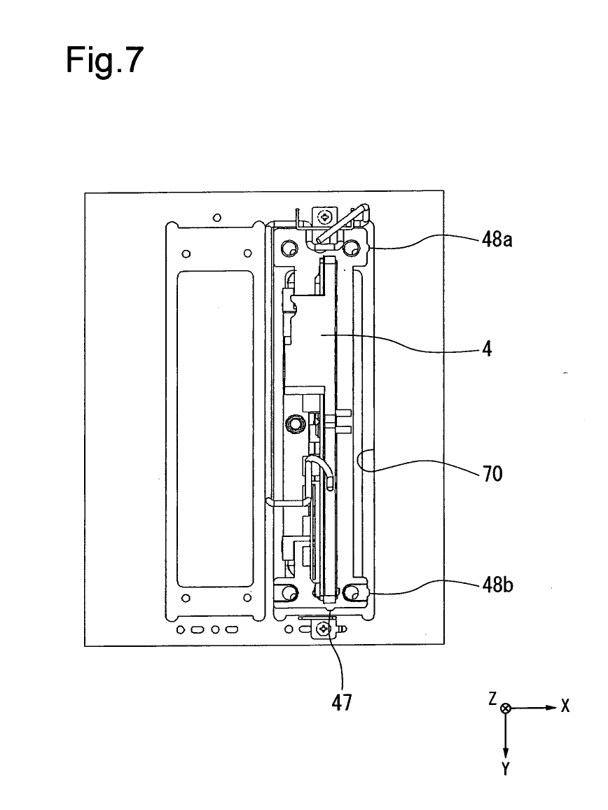

FIG. 6 and FIG. 7 are explanatory diagrams of operation of disposing the liquid jet head on the carriage. It is to be noted that FIG. 6 is a perspective view while FIG. 7 is a plan view. First, as illustrated in FIG. 6, the attaching base 40 of the liquid jet head 4 is disposed in the groove portion 70 in the carriage 62a. At this stage, as illustrated in FIG. 7, there is space between a tip of the first protrusion 47 of the liquid jet head 4 and the corresponding side surface of the groove portion 70, and there is space between tips of the pair of second protrusions 48a and 48b and the corresponding side surface of the groove portion 70.

The lever 80 is rotated in the +θ direction (about an X-axis) from the state illustrated in FIG. 6.

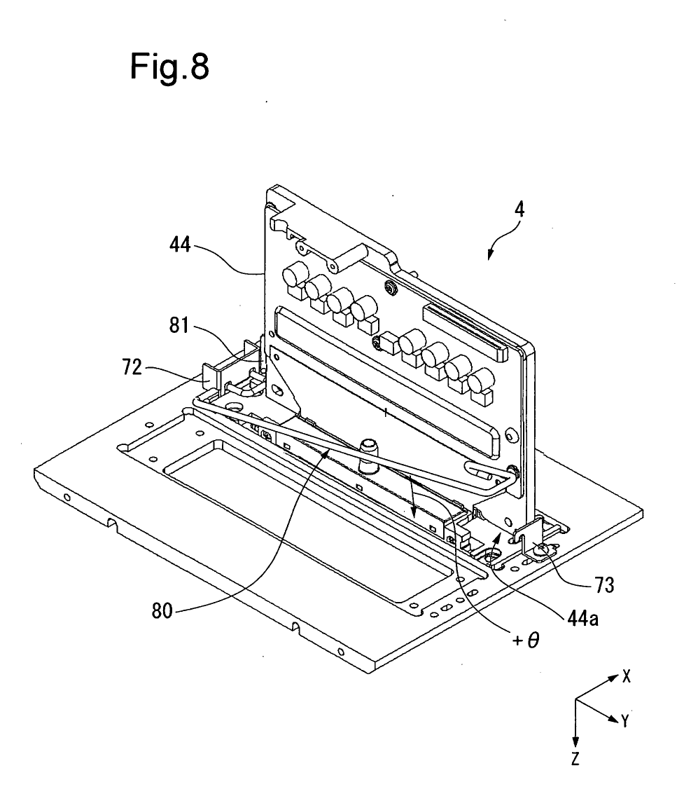

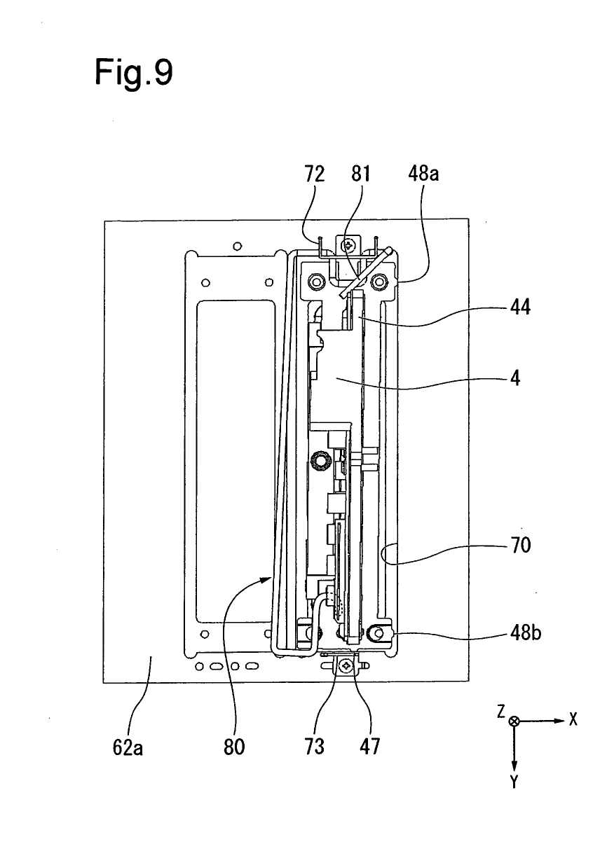

FIG. 8 and FIG. 9 are explanatory diagrams of pressing operation by the first pressing portion. It is to be noted that FIG. 8 is a perspective view while FIG. 9 is a plan view. As illustrated in FIG. 8, when the lever 80 is rotate by the angle of +θ, the first pressing portion 81 of the lever 80 is brought into abutting contact with the side edge portion of the base plate 44 of the liquid jet head 4. As illustrated in FIG. 9, the first pressing portion 81 obliquely extends in the −X direction and in the +Y direction, and thus, the base plate 44 is first pressed in the +X direction. This moves the supporting portion 72 side of the liquid jet head 4 in the +X direction, and the tip of the second protrusion 48a on the supporting portion 72 side is brought into abutting contact with the corresponding side surface of the groove portion 70. As a result, positioning of the supporting portion 72 side of the liquid jet head 4 with respect to the carriage 62a in the X direction is carried out (supporting portion side short side direction fixing step).

The lever 80 is further rotated, and the end portion of the base plate 44 on the supporting portion 72 side is pressed in the +Y direction. This moves the whole liquid jet head 4 in the +Y direction while the tip of the second protrusion 48a slides along the corresponding side surface of the groove portion 70. As a result, the tip of the first protrusion 47 is brought into abutting contact with the corresponding side surface of the groove portion 70, and positioning of the whole liquid jet head 4 with respect to the carriage 62a in the Y direction is carried out (long side direction fixing step). At this stage, the tip of the second protrusion 48b on the engaging portion 73 side is not in abutting contact with the corresponding side surface of the groove portion 70.

The lever 80 is further rotated in the +θ direction from the state illustrated in FIG. 8.

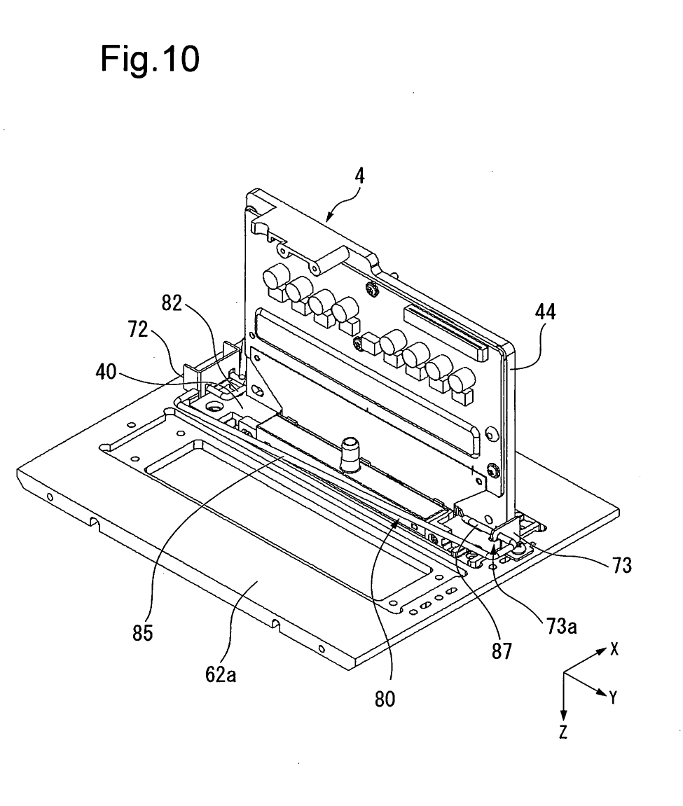

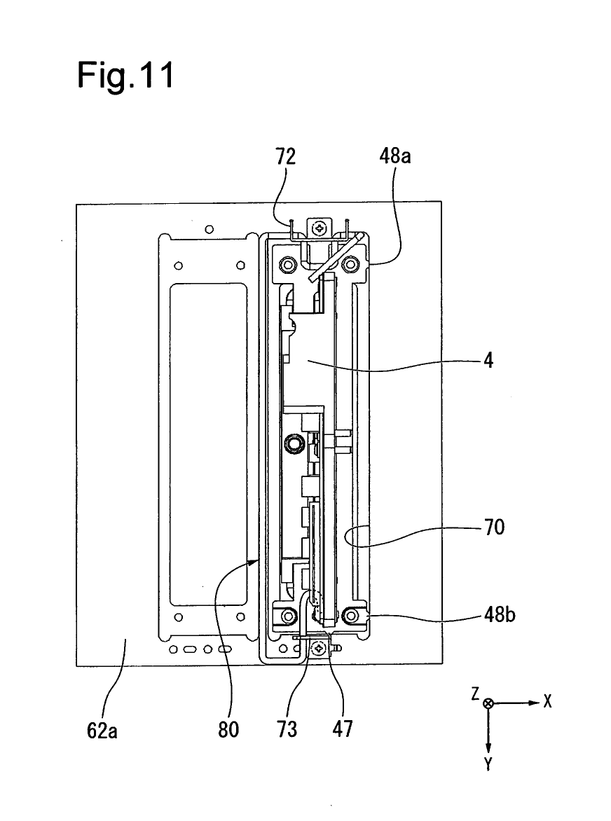

FIG. 10 and FIG. 11 are explanatory diagrams of pressing operation by the second pressing portion and the third pressing portion. It is to be noted that FIG. 10 is a perspective view while FIG. 11 is a plan view. As illustrated in FIG. 10, the lever 80 is rotated until the linear portion 85 of the lever 80 is almost horizontal. It is to be noted that, as illustrated in FIG. 5(b), the plane including the second pressing portion 82 is disposed in the +θ direction with respect to the plane including the linear portion 85 and the rotation shaft portion 86. Therefore, when the lever 80 is rotated until the linear portion 85 is almost horizontal as illustrated in FIG. 10, the second pressing portion 82 is rotated below a horizontal line. This causes the second pressing portion 82 to press the supporting portion 72 side of the attaching base 40 of the liquid jet head 4 in the +Z direction. As a result, positioning of the supporting portion 72 side of the liquid jet head 4 with respect to the carriage 62a in the Z direction is carried out (supporting portion side normal direction fixing step).

At this point in time, positioning of the supporting portion 72 side of the liquid jet head 4 in the X direction has been already carried out, and thus, the positioning in the Z direction does not interfere with the positioning in the X direction. Therefore, positioning of the supporting portion 72 side of the liquid jet head 4 in the X direction and in the Z direction may be carried out with high accuracy.

Next, as illustrated in FIG. 10, the folded portion 87 of the lever 80 is engaged with the engaging portion 73. As described above, the lever 80 (see FIG. 5) includes the U-shaped portion 88 which obliquely extends in the +X direction and in the +Z direction and then which extends in the +Y direction from the −Y direction end portion of the folded portion 87, and further, includes the third pressing portion 83 which extends in the +Y direction from the tip of the U-shaped portion 88. Therefore, when the folded portion 87 is engaged, the third pressing portion 83 is brought into abutting contact with a corner portion 44a (see FIG. 8) formed by the attaching base 40 and the base plate 44 of the liquid jet head 4. It is to be noted that the lever 80 is formed so that the distance between the folded portion 87 and the third pressing portion 83 is a little longer than the distance between the engaging concave portion 73a of the engaging portion 73 and the corner portion 44a of the liquid jet head 4. Therefore, when the folded portion 87 is engaged with the engaging concave portion 73a, the third pressing portion 83 presses the corner portion 44a with the U-shaped portion 88 being elastically deformed. This causes the third pressing portion 83 to press the engaging portion 73 side of the base plate 44 of the liquid jet head 4 in the +X direction and to press the engaging portion 73 side of the attaching base 40 in the +Z direction. As a result, as illustrated in FIG. 11, the tip of the second protrusion 48b on the engaging portion 73 side of the liquid jet head 4 is brought into abutting contact with the corresponding side surface of the groove portion 70, and positioning of the engaging portion 73 side of the liquid jet head 4 with respect to the carriage 62a in the X direction is carried out (engaging portion side short side direction fixing step). Further, positioning of the engaging portion 73 side of the liquid jet head 4 with respect to the carriage 62a in the Z direction is carried out (engaging portion side normal direction fixing step).

In this way, the liquid jet head 4 is fixed under a state in which positioning thereof with respect to the carriage 62a in the three directions of X, Y, and Z is carried out. It is to be noted that, as described above, the liquid jet head 4 is formed in the shape of a rectangle under a state in which the direction of arrangement of the nozzle holes is the direction of the long side thereof. In this embodiment, positioning of the supporting portion 72 side and positioning of the engaging portion 73 side of the liquid jet head 4 in the direction of the long side are carried out separately, and thus, positioning of the liquid jet head 4 may be carried out with high accuracy.

As described in detail above, the carriage unit 62 according to this embodiment has a structure which includes the lever 80 for, by rotating with respect to and engaging with the carriage 62a, detachably fixing the liquid jet head 4, and positioning of the liquid jet head 4 with respect to the carriage 62a is carried out with the rotating operation and the engaging operation of the lever 80.

According to the structure, the lever 80 for detachably fixing the liquid jet head 4 by rotating and engaging the lever 80 with respect to the carriage 62a is included, and thus, attachment/detachment of the liquid jet head 4 may be conducted easily only by rotating and engaging the lever 80. Further, positioning of the liquid jet head 4 is carried out with the rotating operation and the engaging operation of the lever 80, and thus, positioning of the liquid jet head 4 may be carried out easily.

In this way, the liquid jet head 4 is not screwed against the carriage 62a, and thus, attachment/detachment of the liquid jet head may be conducted with one-touch operation. Further, the work to adjust positioning associated with attachment of the liquid jet head 4 becomes unnecessary. Further, reproducibility of the position of the liquid jet head 4 when the liquid jet head 4 is reattached is excellent.

It is to be noted that carrying out positioning of the liquid jet head at least in the horizontal direction (in the X direction and in the Y direction) with the rotating operation and the engaging operation of the lever 80 is sufficient. Positioning in the vertical direction (in the Z direction) in this case may be carried out by screwing or the like. By employing screwing in combination therewith, the liquid jet head may be fixed to the carriage 62a more firmly.

Further, a structure is adopted in which, by causing the first protrusion 47 and the second protrusions 48a and 48b of the liquid jet head 4 to be in abutting contact with the corresponding side surfaces of the groove portion 70 in the carriage 62a, positioning of the liquid jet head 4 with respect to the carriage 62a in the Y direction and in the X direction is carried out.

According to the structure, positioning of the liquid jet head 4 may be carried out with high accuracy.

### Second Embodiment

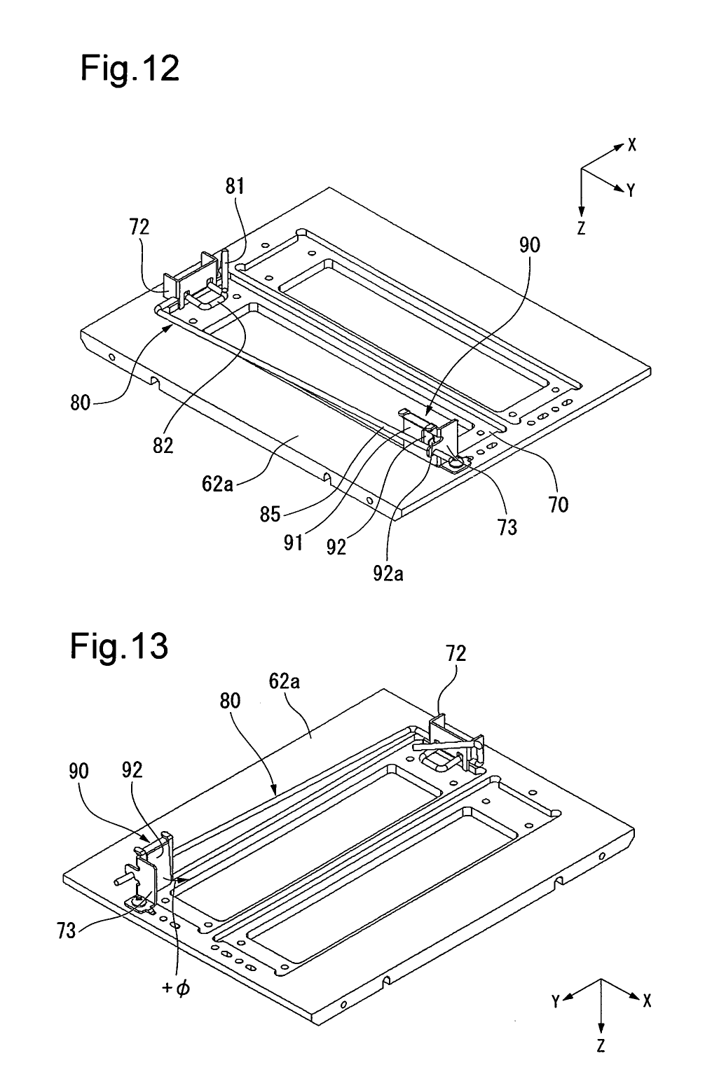

FIG. 12 and FIG. 13 are perspective views of a carriage in a carriage unit according to a second embodiment. In the first embodiment illustrated in FIG. 4, the third pressing portion 83 is provided on the engaging portion 73 side of the lever 80, but the second embodiment illustrated in FIG. 12 is different in that a pressing mechanism 90 is provided for the carriage 62a. It is to be noted that detailed description of a structure which is similar to that of the first embodiment is omitted.

As illustrated in FIG. 12, the first pressing portion 81 and the second pressing portion 82 which are the same as those in the first embodiment are provided for the lever 80 according to the second embodiment, but the folded portion and the third pressing portion according to the first embodiment are not provided. According to the second embodiment, the engaging portion 73 of the carriage 62a is engaged with the linear portion 85 of the lever 80.

Further, instead of the third pressing portion according to the first embodiment, the pressing mechanism 90 is provided for the carriage 62a according to the second embodiment. The pressing mechanism 90 is disposed at a +Y direction end portion of the groove portion along a −X direction edge 70.

The pressing mechanism 90 includes a base portion 91 which is provided so as to be upright in the −Z direction from the −X direction edge of the groove portion 70 and a movable plate 92 which is disposed along a +X direction surface of the base portion 91. An upper end of the movable plate 92 is bent toward the −X direction and is coupled to an upper end of the base portion 91 via a hinge. This causes the movable plate 92 to be able to rotate in a +φ direction (about a Y-axis) illustrated in FIG. 13.

Reference is again made to FIG. 12. A claw portion 92a is provided so as to be upright from a rear surface of the movable plate 92 in the −X direction. The claw portion 92a is adapted to be, when the lever 80 is engaged with the engaging portion 73, pushed out in the +X direction by being brought into abutting contact with the linear portion 85 of the lever 80.

In the carriage unit according to the second embodiment, in order to position and fix the liquid jet head, first, similarly to the case of the first embodiment, the lever 80 is rotated. This causes the first pressing portion 81 of the lever 80 to press the supporting portion 72 side of the liquid jet head in the +X direction and in the +Y direction, and positioning of the supporting portion 72 side of the liquid jet head in the X direction is carried out, and in addition, positioning of the whole liquid jet head in the Y direction is carried out. Further, the second pressing portion 82 of the lever 80 presses the supporting portion 72 side of the liquid jet head in the Z direction and positioning is carried out.

Next, the lever 80 is engaged with the engaging portion 73. Here, the linear portion 85 of the lever 80 is in abutting contact with the claw portion 92a of the movable plate 92 to push out the claw portion 92a in the +X direction. This rotates the movable plate 92 in the +φ direction as illustrated in FIG. 13 to press the engaging portion 73 side of the liquid jet head (not shown) in the +X direction. As a result, positioning on the engaging portion 73 side of the liquid jet head in the X direction may be carried out. It is to be noted that positioning of the supporting portion 72 side of the liquid jet head in the Z direction has been already carried out, and thus, positioning on the engaging portion 73 side in the Z direction may be omitted. Further, positioning on the engaging portion 73 side in the Z direction may be carried out by screwing or the like. By employing screwing in combination therewith, the liquid jet head may be fixed to the carriage 62a more firmly.

As described above in detail, the carriage unit according to the second embodiment has a structure which includes the pressing mechanism 90 for carrying out positioning by pressing the engaging portion 73 side of the liquid jet head in the X direction in synchronization with the engaging operation of the lever 80, on the engaging portion 73 side of the carriage 62a.

In this structure, similarly to the case of the first embodiment, attachment/detachment of the liquid jet head may be conducted easily only by rotating and engaging the lever 80. Further, positioning of the liquid jet head may be carried out easily with the rotating operation and the engaging operation of the lever 80.

### Third Embodiment

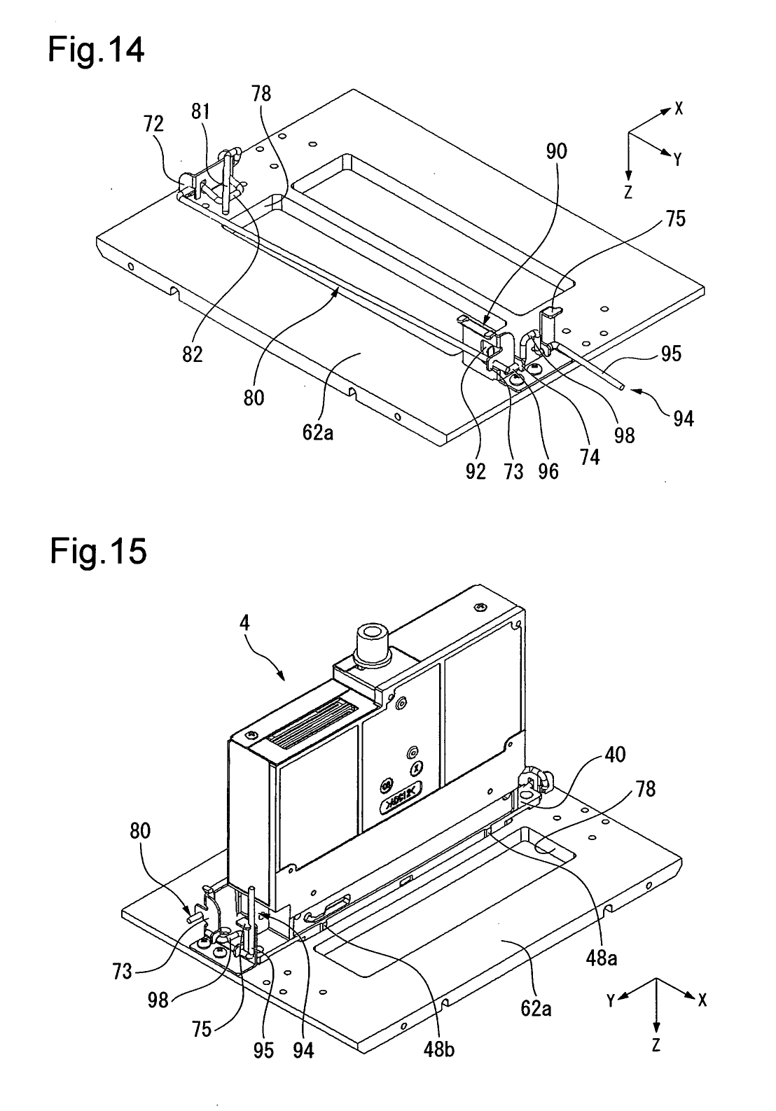

FIG. 14 to FIG. 16 are perspective views of a carriage unit according to a third embodiment. It is to be noted that, in FIG. 14, the liquid jet head is omitted and only the carriage 62a is illustrated. In the third embodiment, in addition to the pressing mechanism 90 according to the second embodiment, a second lever 94 is provided. It is to be noted that detailed description of a structure which is similar to those of the above-mentioned embodiments is omitted.

In the carriage 62a according to the first embodiment illustrated in FIG. 4, the groove portion 70 as a housing portion for housing the attaching base 40 of the liquid jet head 4 is provided, and the through hole is formed in the middle thereof. On the other hand, in the carriage 62a according to the third embodiment illustrated in FIG. 14 to FIG. 16, as a housing portion for housing a part of the attaching base 40 of the liquid jet head 4, only a through hole 78 is formed. It is to be noted that an outer shape of a lower half portion of the attaching base 40 is formed to be smaller than the through hole 78, while an outer shape of an upper half portion of the attaching base 40 is formed to be larger than the through hole 78. This causes the lower half portion of the attaching base 40 to be housed in the through hole 78 and the upper half portion of the attaching base 40 to be mounted on an upper surface of the carriage 62a. It is to be noted that, similarly to the case of the first embodiment, the first protrusion (not shown) and the second protrusions 48a and 48b formed on the side surfaces of the attaching base 40 are brought into abutting contact with the corresponding side surfaces of the through hole 78.

As illustrated in FIG. 14, the structure of the lever 80, the supporting portion 72, the engaging portion 73, and the pressing mechanism 90 according to the third embodiment is similar to that according to the second embodiment. More specifically, the first pressing portion 81 and the second pressing portion 82 according to the second embodiment are provided for the lever 80 according to the third embodiment. Further, the pressing mechanism 90 according to the second embodiment is provided for the carriage 62a according to the third embodiment.

In addition, the second lever 94 is provided for the carriage 62a according to the third embodiment. The second lever 94 is formed by bending a steel wire material such as stainless steel. It is to be noted that a second supporting portion 74 for rotatably supporting the second lever 94 and a second engaging portion 75 for engaging with the second lever 94 are provided adjacent to the through hole 78 in the +Y direction.

The second lever 94 includes a linear portion 95 and a rotation shaft portion 96 which extends in the −X direction from an end portion of the linear portion 95. The rotation shaft portion 96 is disposed outside the through hole 78 in the +Y direction and is rotatably supported by the second supporting portion 74.

The second lever 94 includes a fourth pressing portion 98 which is formed by bending a middle portion in a length direction of the rotation shaft portion 96. The fourth pressing portion 98 is provided for pressing the engaging portion 73 side of the attaching base of the liquid jet head in the +Z direction with rotating operation of the second lever 94.

In the carriage unit according to the third embodiment, in order to position and fix the liquid jet head, first, similarly to the case of the second embodiment, the lever 80 is rotated. This causes the first pressing portion 81 of the lever 80 to press the supporting portion 72 side of the liquid jet head in the +X direction and in the +Y direction, and positioning of the supporting portion 72 side of the liquid jet head in the X direction is carried out, and in addition, positioning of the whole liquid jet head in the Y direction is carried out. Further, the second pressing portion 82 of the lever 80 presses the supporting portion 72 side of the liquid jet head in the Z direction and positioning is carried out.

Next, similarly to the case of the second embodiment, the lever 80 is engaged with the engaging portion 73. Here, the movable plate 92 of the pressing mechanism 90 is rotated to press the engaging portion 73 side of the liquid jet head (not shown) in the +X direction, and positioning is carried out.

Next, as illustrated in FIG. 15, the second lever 94 is rotated and the linear portion 95 thereof is engaged with the second engaging portion 75. This causes the fourth pressing portion 98 to be rotated below the horizontal line and to press the engaging portion 73 side of the attaching base 40 of the liquid jet head 4 in the +Z direction. As a result, positioning of the engaging portion 73 side of the liquid jet head 4 with respect to the carriage 62a in the Z direction is carried out.

In this way, the liquid jet head 4 is fixed under a state in which positioning thereof with respect to the carriage 62a in the three directions of X, Y, and Z is carried out.

As described above in detail, the carriage unit according to the third embodiment has a structure which includes the second lever 94 for carrying out positioning by pressing the engaging portion 73 side of the liquid jet head 4 in the Z direction, on the engaging portion 73 side of the liquid jet head 4.

In this structure, attachment/detachment of the liquid jet head 4 may be conducted easily only by rotating and engaging the lever 80 and the second lever 94. Further, positioning of the liquid jet head 4 may be carried out easily with the rotating operation and the engaging operation of the lever 80 and the second lever 94.

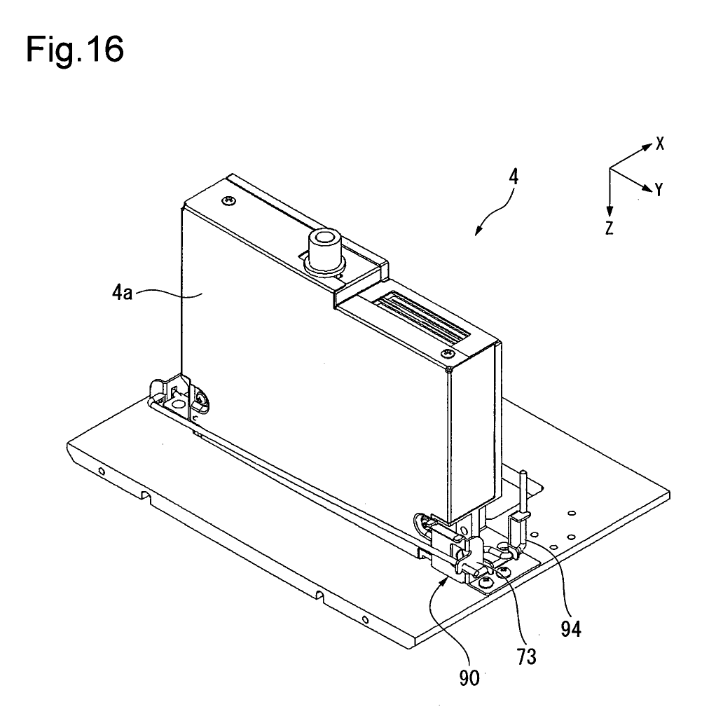

It is to be noted that, in the first embodiment illustrated in FIG. 4, the structure in which the third pressing portion 83 of the lever 80 presses the corner portion 44a (see FIG. 8) formed by the attaching base 40 and the base plate 44 of the liquid jet head is adopted. However, when the liquid jet head 4 is covered with a cover 4a as illustrated in FIG. 16, the third pressing portion can not press the corner portion.

On the other hand, according to the second embodiment and the third embodiment, instead of the third pressing portion according to the first embodiment, the pressing mechanism 90 is included. With this, even if the liquid jet head 4 is covered with the cover 4a, the engaging portion 73 side of the liquid jet head 4 may be pressed in the X direction to carry out positioning. Further, according to the third embodiment, the second lever 94 is included, and thus, even if the liquid jet head 4 is covered with the cover 4a, the engaging portion 73 side of the liquid jet head 4 may be pressed in the Z direction to carry out positioning.

It is to be noted that the technical range of the present invention is not limited to the embodiments described above, and various modifications of the embodiments described above which fall within the gist of the present invention are also included. More specifically, specific materials, layer structures, and the like in the embodiments are only exemplary and appropriate modifications are possible.

For example, the structures of the liquid jet recording apparatus illustrated in FIG. 1, of the liquid jet head illustrated in FIG. 2, of the head chip illustrated in FIG. 3, and the like are only exemplary and adoption of other structures is also possible.

Further, in the embodiments described above, four liquid jet heads 4 are mounted on one carriage 62a as illustrated in FIG. 1, but the number of the liquid jet heads 4 which are mounted on one carriage 62a may be three or smaller, or five or larger.

Further, in the embodiments described above, the plurality of liquid jet heads 4 are linearly arranged, but the arrangement may be staggered.

Further, in the embodiments described above, the liquid jet heads 4 are disposed so that the direction of the long side of the liquid jet heads 4 (the direction of arrangement of the nozzle holes) is orthogonal to the auxiliary scan direction of the carriage 62a, but the liquid jet heads 4 may be disposed so that the angle formed by the direction of the long side of the liquid jet heads 4 and the auxiliary scan direction of the carriage 62a is other than a right angle. This makes smaller the pitch of liquid jetting in the main scan direction, and thus, recording may be performed in high resolution.

Further, the shape of the lever 80 illustrated in FIG. 4 is exemplary, and other shapes are also possible.

Further, in the embodiments described above, one lever 80 fixes one liquid jet head, but a plurality of liquid jet heads 4 may be simultaneously fixed with only a single rotating operation and a single engaging operation by coupling a plurality of levers 80.

Further, in the embodiments described above, the first protrusion 47 and the second protrusions 48a and 48b are formed on side surfaces of the liquid jet head 4, but they may be formed on side surfaces of the housing portion in the carriage 62a.

Further, in the embodiments, in the fixing step, when the first pressing portion 81 presses the liquid jet head 4 in the −X direction and in the +Y direction, first, the second protrusion 48a is brought into abutting contact with the corresponding side surface of the groove portion 70 to carry out the positioning in the X direction, and then, the first protrusion 47 is brought into abutting contact with the corresponding side surface of the groove portion 70 to carry out the positioning in the Y direction. This is due to factors such as the shape, the mass, and the center of gravity of the liquid jet head 4 described in the embodiments described above, slip resistance determined by surface roughness of the groove portion 70, and the like. In this embodiment, as described above, first, the positioning in the X direction is carried out, and then, the positioning in the Y direction is carried out.

However, the fixing method described in this embodiment may be adopted also when a liquid jet head which is different from that according to this embodiment is fixed. In this case, even if the positioning in the Y direction is carried out before the positioning in the X direction is carried out due to the difference, it does not mean that the case is different from this embodiment. More specifically, the fixing method according to this embodiment does not specify the order of the positioning in the long side and the positioning in the short side of the liquid jet head.

### DESCRIPTION OF SYMBOLS

S . . . recording medium

X . . . direction of a short side

Y . . . direction of a long side

Z . . . direction of a normal

1 . . . liquid jet recording apparatus

2, 3 . . . transfer means (recording medium transfer means)

4 . . . liquid jet head

6 . . . scanning means (carriage moving means)

13 . . . nozzle hole (jetting hole)

47 . . . first protrusion

48a, 48b . . . second protrusion

62 . . . carriage unit

70 . . . groove portion (housing portion)

72 . . . supporting portion

73 . . . engaging portion

78 . . . through hole (housing portion)

80 . . . lever (first lever)

90 . . . pressing mechanism

94 . . . second lever

1. A carriage unit, comprising:
a liquid jet head having a plurality of jetting holes arranged therein, for jetting liquid toward a recording surface of a recording medium; and
a carriage which relatively moves in parallel with the recording surface under a state in which the liquid jet head is fixed thereto, wherein:
the carriage unit further comprises a first lever for detachably fixing the liquid jet head by rotating and engaging the first lever with respect to the carriage; and
the liquid jet head is positioned with respect to the carriage at least in a plane in parallel with the recording surface with rotating operation and engaging operation of the first lever.

2. A carriage unit according to claim 1, wherein:
the liquid jet head is formed in a shape of a rectangle viewed from a direction of a normal to the recording surface under a state in which a direction of arrangement of the plurality of jetting holes is a direction of a long side thereof and a direction orthogonal to the direction of the long side is a direction of a short side thereof;
the carriage comprises: a housing portion for housing at least a part of the liquid jet head; a supporting portion disposed on one side in the direction of the long side adjacent to the housing portion, for rotatably supporting the first lever;
and an engaging portion disposed on an other side in the direction of the long side adjacent to the housing portion, for engaging with the first lever;
a first protrusion which protrudes in the direction of the long side and a second protrusion which protrudes in the direction of the short side are formed on a side surface of one of the liquid jet head and the housing portion; and
the liquid jet head is positioned with respect to the carriage in the direction of the long side and in the direction of the short side by causing the first protrusion and the second protrusion to be in abutting contact with a side surface of the other of the liquid jet head and the housing portion.

3. A carriage unit according to claim 2, further comprising a first pressing portion formed on the supporting portion side of the first lever, for carrying out positioning of the supporting portion side of the liquid jet head with respect to the carriage in the direction of the short side and carrying out positioning of the whole liquid jet head with respect to the carriage in the direction of the long side by pressing the supporting portion side of the liquid jet head with respect to the carriage in the direction of the short side and in the direction of the long side with the rotating operation of the first lever.

4. A carriage unit according to claim 3, further comprising a second pressing portion formed on the supporting portion side of the first lever, for carrying out positioning by pressing the supporting portion side of the liquid jet head with respect to the carriage in the direction of the normal with the rotating operation of the first lever,
wherein after the first pressing portion carries out positioning of the liquid jet head in the direction of the long side and in the direction of the short side, the second pressing portion carries out positioning of the liquid jet head in the direction of the normal.

5.-11. (canceled)

12. A method for fixing a carriage unit, the carriage unit comprising:
a liquid jet head having a plurality of jetting holes arranged therein, for jetting liquid toward a recording surface of a recording medium, the liquid jet head being formed in a shape of a rectangle viewed from a direction of a normal to the recording surface under a state in which a direction of arrangement of the plurality of jetting holes is a direction of a long side thereof and a direction orthogonal to the direction of the long side is a direction of a short side thereof; and
a carriage which relatively moves in parallel with the recording surface under a state in which the liquid jet head is fixed thereto,
the method for fixing a carriage unit being a method for fixing the liquid jet head with respect to the carriage,
the method for fixing a carriage unit comprising:
a long side direction fixing step of fixing the liquid jet head with respect to the carriage in the direction of the long side;
a short side direction fixing step of fixing the liquid jet head with respect to the carriage in the direction of the short side; and
a normal direction fixing step of fixing the liquid jet head with respect to the carriage in the direction of the normal, the normal direction fixing step being completed after the long side direction fixing step and the short side direction fixing step are completed or simultaneously with completion of the long side direction fixing step and the short side direction fixing step.
